(19) United States
(12) Patent Application Publication
(10) Pub. No.: US 2025/0271202 A1
(43) Pub. Date: Aug. 28, 2025

(54) POLYMER FREEZER STORAGE RACK

(71) Applicant: GNOSKO BIO INC, Wayne, PA (US)

(72) Inventor: William Robert Wendel, Wayne, PA (US)

(21) Appl. No.: 18/586,035

(22) Filed: Feb. 23, 2024

(51) Int. Cl. F25D 25/02

(52) U.S. Cl. CPC F25D 25/025

(57) ABSTRACT

This document discloses a freezer storage rack for storing samples in a freezer. The freezer storage rack can include a housing and a first drawer disposed within the housing. At least one of the housing or the first drawer can include a polymer material and be radio frequency (RFID frequencies) transparent. The drawer or housing can also be visually transparent. The housing and the first drawer can both comprise polyethylene terephthalate glycol (PETG).

### BACKGROUND

This disclosure relates to the field of storage racks, and particularly storage racks suitable for organizing samples stored in freezers at temperatures well below zero degrees Centigrade (° C.).

Many types of medical samples are stored in freezers at very cold temperatures (often around −80° C.) to ensure preservation. In some scenarios, the samples may need to be stored for many years and later accessed. Organization of and access to stored samples can be difficult. Conventional solutions use metal racks, but these present several significant drawbacks. For example, metal racks are not transparent, quickly become frosted, and are not safe to touch without heavy gloves. Accordingly, finding stored samples and storing new samples can be a time-consuming, energy-consuming, and generally cumbersome practice.

This patent document describes an apparatus that addresses at least some of the issues described above and/or other issues.

### SUMMARY

In a first aspect, this document discloses a freezer storage rack for storing samples in a freezer. The freezer storage rack includes a housing; and a first drawer disposed within the housing. At least one of the housing or the first drawer includes a polymer material and is radio frequency transparent. At least one of the housing or the drawer can also be visually transparent. The housing and the first drawer can both comprise polyethylene terephthalate glycol (PETG).

Consistent with disclosed embodiments, at least one of the housing or the drawer can include a plurality of parts, the plurality of parts being solvent bonded together. The housing can include a plurality of shelves. The freezer storage rack can further include a second drawer, a third drawer, and a fourth drawer. Each of the first, second, third, and fourth drawers can be disposed within the housing on a different shelf of the plurality of shelves. The first, second, third, and fourth drawers can each be sized and shaped to receive a plurality of sample boxes.

In some embodiments, the freezer storage rack can be configured to function at temperatures between about −25 and −80 degrees Celsius. In some embodiments, the freezer storage rack can be configured to function at temperatures between about −40 and −80 degrees Celsius. In some embodiments, the freezer storage rack can be configured to function at temperatures between about −50 and −80 degrees Celsius.

In another aspect, this document discloses a method for organizing frozen samples. The method can include tagging each of a plurality of samples with an RFID tag, placing the plurality of samples inside a freezer within a plurality of RF transparent polymer racks, opening the freezer containing a plurality of samples stored within the plurality of RF transparent racks, selecting a first rack of the plurality of racks for scanning, scanning the first rack using an RFID scanner, and receiving, from the RFID scanner or a computing device associated with the RFID scanner, an indication of at least one sample or group of samples stored within the first rack. The method can further include opening a drawer of the first rack, locating the sample or group of samples, and removing the sample or group of samples from the first rack. The first rack can be at least partially constructed from RF transparent polymer. The polymer can be polyethylene terephthalate glycol (PETG).

Each of the plurality of racks can include a plurality of drawers. Each of the plurality of drawers can be configured to receive a plurality of samples. The drawers can include an RF transparent polymer.

In some embodiments, the drawer or drawers can include a front panel constructed of the RF transparent polymer. The RF transparent polymer can be polyethylene terephthalate glycol (PETG). The drawer or drawers can further include a back panel, a side panel; and a bottom. The front panel, back panel, and side panel can each be solvent-bonded to the bottom.

### BRIEF DESCRIPTION OF THE DRAWINGS

FIG. 1 is a perspective view of an example freezer storage rack.

FIG. 2A is a perspective view of an example freezer storage rack drawer.

FIG. 2B is a perspective views of the example freezer storage rack drawer of FIG. 2A with sample boxes.

FIG. 3 is a front view of an example freezer storage rack housing.

FIG. 4 is a perspective view of the example freezer storage rack housing of FIG. 3.

FIG. 5A is a front perspective view of the example freezer storage rack housing of FIG. 3.

FIG. 5B is a back perspective view of the example freezer storage rack housing of FIG. 3.

FIG. 6 is an exploded view of the example freezer storage rack housing of FIG. 3.

FIG. 7 is an exploded view of the example freezer storage rack drawer of FIG. 2A.

FIG. 8 is a perspective view of another example freezer storage track.

FIG. 9 is a flowchart illustrating an example method for method for organizing frozen samples, consistent with disclosed embodiments.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

In this document, the term “connected”, when referring to two physical structures, means that the two physical structures touch each other. Devices that are connected may be secured to each other, or they may simply touch each other and not be secured.

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a device of which the components are a part is oriented in a first direction. The relative orientations of the components may be reversed, or the components may be on the same plane, if the orientation of the structure that contains the components is changed. The claims are intended to include all orientations of a device containing such components.

This disclosure is not limited to the particular systems, methodologies or protocols described, as these may vary. The terminology used in this description is for the purpose of describing the particular versions or embodiments only, and is not intended to limit the scope.

In various embodiments, a polymer freezer storage rack is provided. The rack can be configured to hold a variety of samples for storing in a freezer. For example, samples can include biological or medical samples such as (but not limited to) blood samples, tissue samples, hair samples, vaccines, and bacteria samples; standards, reference materials, reagents, certain chemicals, or other materials. Such samples may be stored for various reasons including to preserve the samples for later use or for research purposes, to keep records of DNA, to keep records of bacteria, etc. Biological samples are often stored at extreme cold temperatures (as low as −80° C.) to ensure preservation. In some scenarios, the samples may need to be stored for many years and later accessed. Organization of and access to stored samples can be difficult and cumbersome.

Conventional solutions use metal racks, but these present several significant drawbacks. For example, metal racks are not transparent, quickly become frosted, and are not safe to touch without heavy gloves. Accordingly, finding stored samples and storing new samples can be a time-consuming, energy-consuming, and generally cumbersome practice. Disclosed embodiments provide polymer freezer storage racks that do not suffer from such drawbacks.

The disclosed polymer freezer storage racks can be radio frequency (RF) transparent. As used herein, radio frequency transparent means that the structure and materials of the polymer freezer storage racks permit enough transmission of radio frequencies for RFID tags associated with samples stored in the racks to be scanned through the racks (i.e., without opening the freezer storage racks). Actual radio frequencies can vary based on the type of RFID tag used. Various disclosed embodiments can function with low frequency RFID systems (between 30 and 300 KHz), high frequency systems (between 3 and 30 MHz), and Ultra High Frequency (UHF) system (between 300 MHz and 3 GHz). More specifically, disclosed embodiments can function in a UHF system employing frequencies between 860-960 MHz. RFID tags can be passive tags (using the energy from the scanning device) or active tags (having their own power source).

Additionally, the disclosed polymer freezer storage racks can be visually transparent. Visual transparency relates to the amount of light be transmitted through the material of the freezer storage racks. As used herein, visual transparency means about 80% or more of light is transmitted through the material of the freezer storage racks. Such visual transparency permits a user to view the samples or boxes within a freezer storage rack or a within a particular drawer of the rack. A greater level of visual transparency (i.e., approaching 100%) will permit the user to easily see the samples within the rack. A lower level of transparency may obscure some detail of the samples within the rack, but still permit users to determine if samples are located within a particular drawer or area of the rack without opening it.

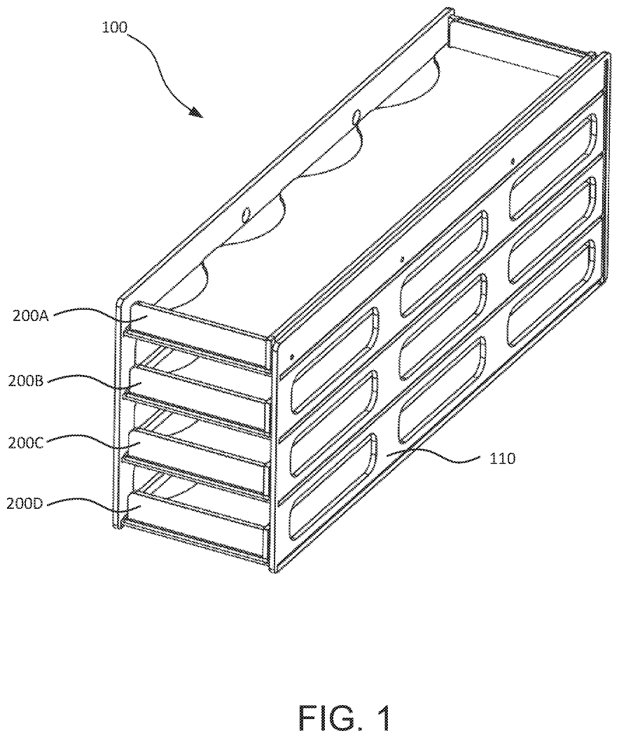

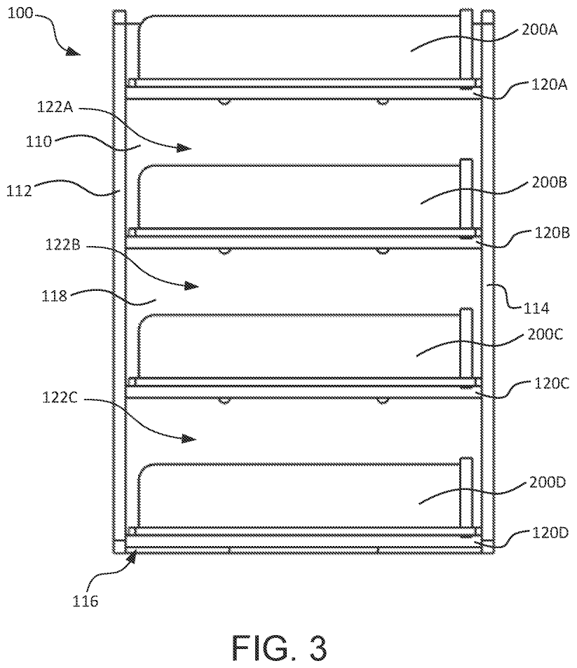

FIG. 1 is a perspective view of an example freezer storage rack 100. Freezer storage rack 100 can include a housing 110 and plurality drawers 200A-D. For example, freezer storage rack 100 can be a freezer storage for storing samples in a freezer including a housing and a first drawer disposed within the housing. FIG. 3 is a front view of the example freezer storage rack 100 of FIG. 1. Housing 110 can include one or more shelves 120A-D. Shelves 120A-D can engage and support drawers 200A-D within housing 110. Shelves 120A-D can separate the interior of housing 110 into openings 122A-C for receiving drawers 200A-D. As illustrated the top of housing 110 can be open. In other embodiments (not shown) a top panel can be placed on housing 110 to enclose housing 110 and cover drawer 200A.

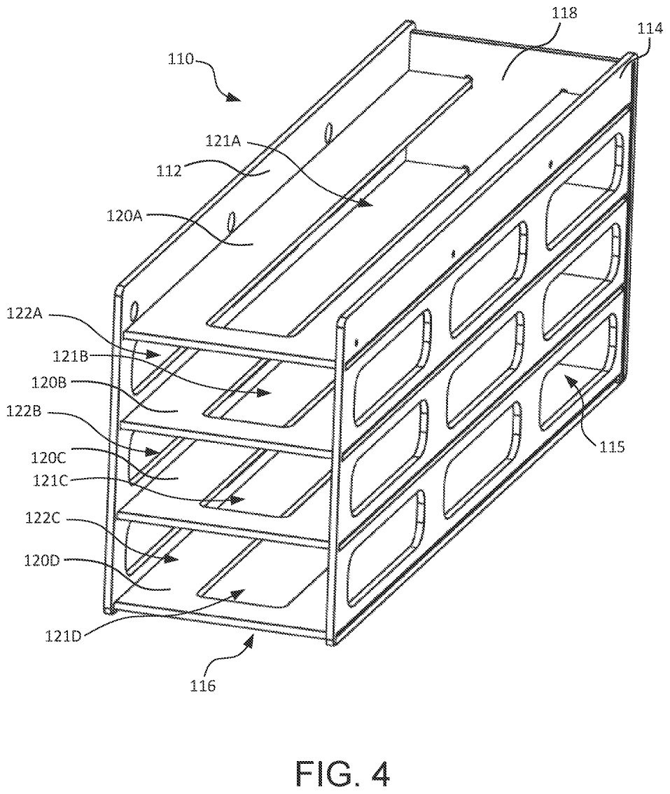

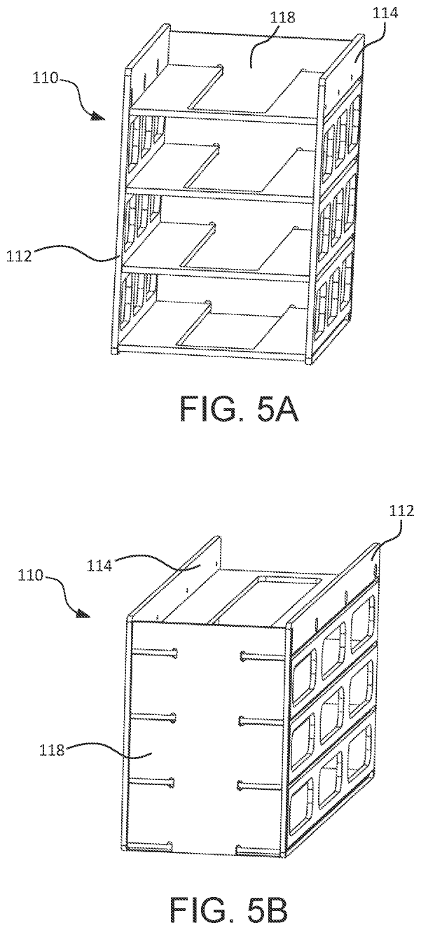

Referring to FIGS. 3-6, housing 110 can include a left side 112, right side 114, and back side 118. Together with shelves 120A-D, these components can form the housing. Shelves 120A-D can include cutouts 121A-D to reduce weight and/or materials. In further embodiments (not shown), housing 110 can further include a door on the front of the housing 110. For example, the door could be a hinged door that swings away from the housing 110 to fully enclose the housing and the drawers. The door could be made from the same material as the rest of housing and drawers (for example, PETG) to permit both visual transparency and RF transparency.

Drawers 200A-D rest on the plurality of corresponding shelves 120A-D. Specifically, each of the first drawer 200A, second drawer 200B, third drawer 200C, and fourth drawer 200D can be disposed within the housing 110 on a different shelf 120A-D of the plurality of shelves. As described in greater detail below, the first, second, third, and fourth drawers 200A-D can each sized and shaped to receive a plurality of sample boxes. Of course, while four drawers (and four corresponding shelves are shown and described in this document, embodiments with more or fewer drawers and shelves are possible.

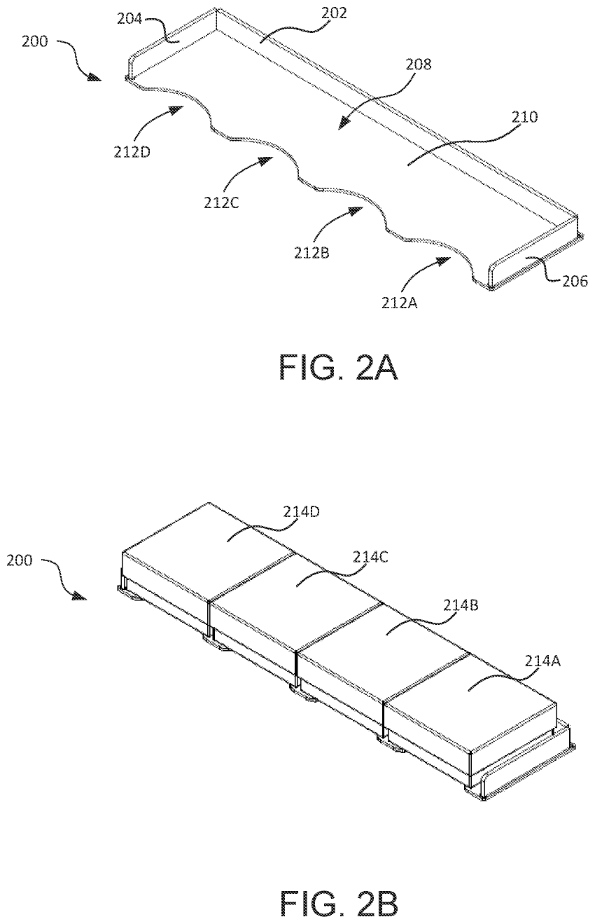

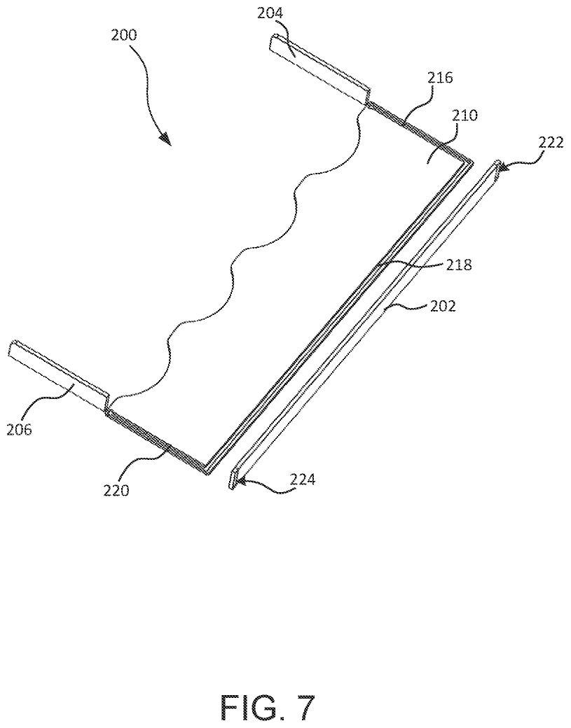

FIG. 2A is a perspective view of an example freezer storage rack drawer. FIG. 7 is an exploded view of the example freezer storage rack drawer of FIG. 2A. Drawer 200 can include a drawer bottom 210, longitudinal rail 202, back rail 204 and front rail 206. The bottom and rails together form a cavity 208 for receiving sample boxes. The side opposite longitudinal rail 202 can be open to permit easy insertion or removal of sample boxes from the drawer.

FIG. 2B is a perspective view of the example freezer storage rack drawer of FIG. 2A with sample boxes placed in the drawer 200. Sample boxes 214A-D can include boxes of various sizes (corresponding to the size of drawer 200 and rack 110) to hold various types of medical samples. For example, boxes 214A-D can be test tube or vial boxes with dividers inside configured to hold the tubes in a vertical orientation (i.e., perpendicular to the bottom 210 of drawer 200. Boxes 214 can be made of any suitable material including cardboard and various plastics. Boxes 214 may generally vary in size based on a particular application, however, the size should be commensurate with the size of drawer 200 used to hold the boxes 214 (and, accordingly, the size of rack 110 and the freezer in which the rack will be placed). Drawer bottom 210 can include one or more scallops 212A-D or similar cutouts. Scallops 212A-D are shown as curved cutouts, but other shapes, such as those having non-rounded edges, are possible. Scallops 212A-D can provide access for a user to remove a sample box 214 from drawer 200 by either pulling box out horizontally (i.e., away from longitudinal rail 202, or vertically (i.e., away from bottom 210). Scallops 212A-D permit the user access to the bottom surface of the box into to grip the box for removal from drawer 200.

The sizing of the housing 110 and drawers 120A-D can depend on several factors including the type of samples being stored, the size of the freezer in which the samples are being stored, the size of shelving within the freezer, the size of boxes in which samples are being stored, etc. For example, sample boxes may be holding small vials and be of a substantially square shape. The square boxes could have widths (side lengths) of, for example, about 3 inches, about 4 inches, about 5 inches, about 6 inches, or other sizes. The boxes could have heights of about 2 inches, about 3 inches, about 4 inches, or other sizes.

In some embodiments, the width and length of the cavity 208 to hold the boxes may be slightly larger than the corresponding dimensions of the boxes to be stored in the drawer. This can permit the boxes to be spaced apart during storage. The height of drawer longitudinal rail 202, drawer back rail 204, and drawer front rail 206 can also vary based on the type of box/sample being stored. In some embodiments, the sample box can be slightly taller than the drawer rails. For example, the sample box could be 0.5 inches taller, 1 inch taller, 1.5 inches taller, or others. The height different will permit the drawer to still hold the sample box in place while being stored, while limiting extra weight of the drawer itself. Of course, dimensions of the drawers and housing 110 will also vary based on the desired configuration of the rack (i.e., the number of drawers and the number of boxes per drawer. For example, configurations could include housings holding 1, 2, 3, 4, 5, or more drawers, with each of the drawers holding 1, 2, 3, 4, 5 or more boxes.

Each of the components of the housing 110 and drawers 200 can be constructed of substantially planar flat sheets of material. The material can be a suitable polymer material, preferably polyethylene terephthalate glycol (PETG). The components can be cut from large sheets of material, for example, using a laser cutter. In other embodiments, the components may be molded or otherwise manufactured using a suitable method. The polymer material can be RF transparent. Additionally, or alternatively, the material can be visually transparent, meaning the corresponding housing and drawers can also be visually transparent to permit users to look through the housing and/or drawers to view samples or sample boxes stored inside.

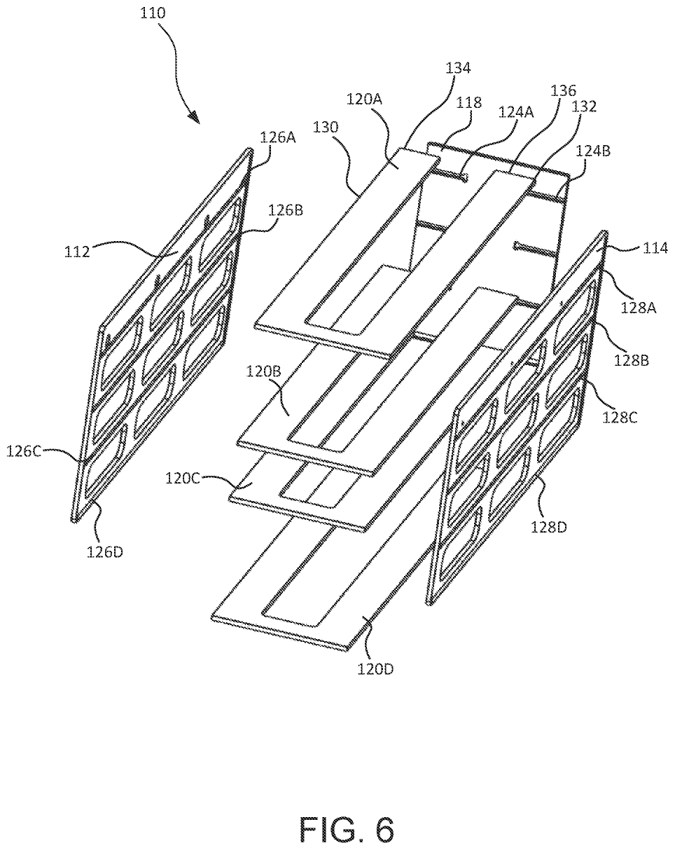

Each of the components of the housing and drawers can include various tabs and slots configured to fit together to form the housing 110 and drawers 200. For example, as illustrated by FIG. 6, sides 112 and 114 can include side shelf slots 126A-D. Edges 130, 132 of shelves 120 can be inserted into side shelf slots 126A-D. Similarly, back side 18 can include a plurality of corresponding back shelf slots 124. Rear edges 134, 136 of shelves 120 can be inserted into back shelf slots 124A, 124 B respectively. While the edges are only labeled on shelf 120A, it is understood that shelves 120B-120D have corresponding edges that engage with back shelf slots 124 and side shelf slots 126A-D.

As another example, referring to FIG. 7, drawer bottom 210 can include a plurality of grooves configured to receive panels to construct the drawer. More specifically, drawer bottom 210 can include back rail groove 216, longitudinal rail slot groove 218, and a front rail groove 220. A lower edge of drawer longitudinal rail 202 can engage with longitudinal rail slot groove 218. In some embodiments, drawer longitudinal rail 202 can include slots 222, 224 to engage with the drawer back rail 204 and drawer front rail 206, respectively.

Accordingly, each of the housing 110 and the drawer(s) 200 can include a plurality of parts. The plurality of parts can be solvent bonded together. In other words, each of the components of the rack 110 and drawer 200 can be assembled together with the slots at described above. The joints between the parts can be exposed to a solvent suitable for bonding the particular polymer used for the parts. For example, in a preferred embodiment, the parts are constructed of PETG. Accordingly, a solvent such as ethyl acetate, MEK, dichloromethane, or other suitable solvent capable of dissolving PETG can be applied to the parts, causing a strong bond between them. In other embodiments, if PETG is not used, a different solvent may be required.

Freezer storage rack 100 is a rack for storing samples in a freezer, at potentially very cold temperatures. For example, freezer storage rack 100 can be configured to function at temperatures between about −25 and −80 degrees Celsius. As another example, the freezer storage rack 100 can be configured to function at temperatures between about −40 and −80 degrees Celsius. As yet another example, freezer storage rack 100 can be configured to function at temperatures between about −50 and −80 degrees Celsius. Functioning at such low temperatures can include permitting relative motion between the housing 110 and drawers 200, removal of drawers 200 from housing 11, maintaining general structural integrity (i.e., not getting too brittle under the extreme cold conditions), and maintaining a surface that is safe for direct contact with human skin (as opposed to, for example, stainless steel, which is not safe to touch at such cold temperatures).

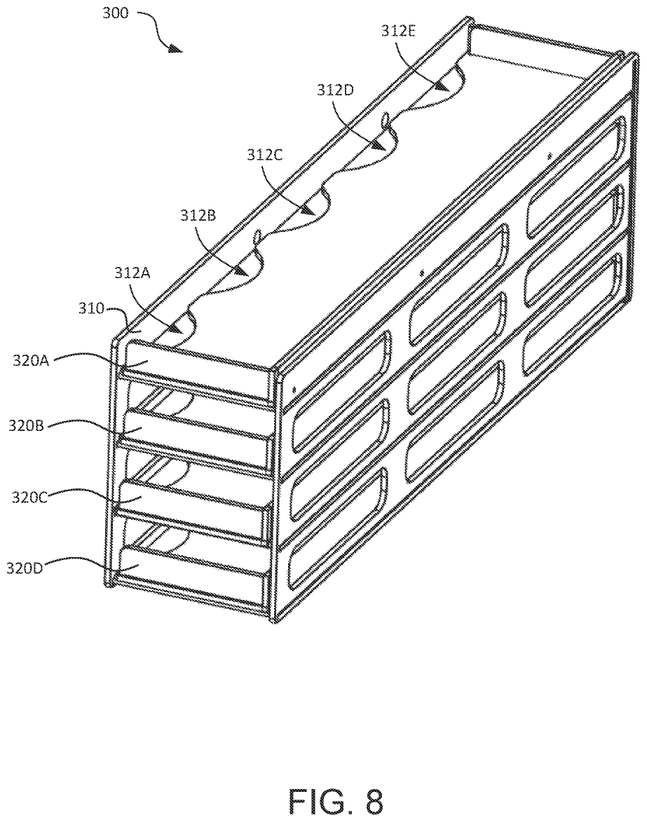

FIG. 8 is a perspective view of another example freezer storage rack 300. While FIGS. 1-7 depict a freezer storage rack 100 having a four drawer configuration storing four sample boxes per drawer, other figuration types are possible. For example, freezer storage rack 300 illustrates a four-drawer configuration storing five sample boxes per drawer. Drawers 320A-D disposed in housing 310 each store five sample boxes each, as evidence by the five scallops 312A-E.

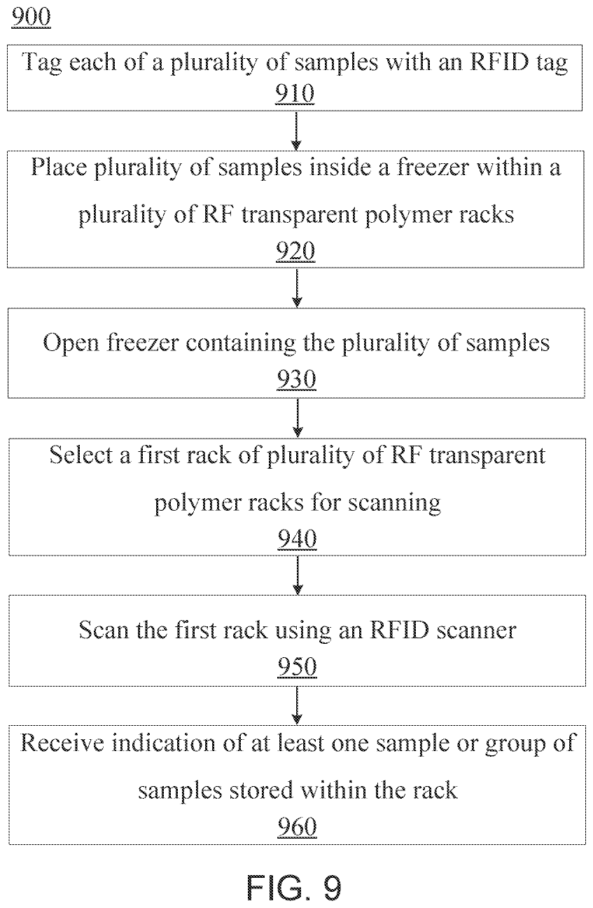

FIG. 9 is a flowchart illustrating an example method 900 for method for organizing frozen samples, consistent with disclosed embodiments. At step 910, method 900 can include tagging each of a plurality of samples with an RFID tag. An RFID tag can be a small label that can be used to identify a particular sample. The RFID tag may tie the sample to a particular identification number, which can be used to identify the particular sample and other information about the sample. The RFID tags can be passive RFID tags, such that they do not require any batteries for operation. At step 920, method 900 can include placing the plurality of samples inside a freezer within a plurality of RF transparent polymer racks. The RF transparent polymer racks can be substantially like any of the RF transparent polymer racks described above. Step 920 may also include closing the freezer after placing the samples within it (i.e., to keep the samples for storage). At step 930, method 900 can include opening the freezer containing the plurality of samples stored within the plurality of RF transparent racks. At step 940, method 900 selecting a first rack of the plurality of racks for scanning. At step 950, method 900 can include scanning the first rack using an RFID scanner. An RFID scanner can be an electronic device (such as a dedicated scanner, mobile device, etc.) capable of receiving information from passive RFID tags. The RFID scanner can be associated with a computing device.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, and mobile electronic devices such as smartphones, personal digital assistants, cameras, tablet computers, laptop computers, media players and the like. In a client-server arrangement, the client device and the server are electronic devices, in which the server implements instructions and/or data to provide a service that the client device accesses via one or more communications links in one or more communications networks. In a virtual machine arrangement, a server may be an electronic device, and each virtual machine or container may also be considered to be an electronic device. In the discussion below, a client device, server device, virtual machine or container may be referred to simply as a “device” for brevity.

The RFID scanner can be associated with the computing device to identify one or more samples and other information associated with the samples (e.g., a name of the sample, a date the sample was taken or stored, a time the sample was taken or stored, a patient associated with the sample, a type of sample, or other information or data associated with the sample). In some embodiments, the scanner or computing system can include an output device such as a monitor or other screen to display information associated with samples. RFID scanner, computing device, and output device can be directly connected (e.g., via a wired connection, Bluetooth connection, or other wireless direct connection). In other embodiments, one or more of the RFID scanner, computing device, and output device can be connected to a network for communication through a server. The server can also be communicatively connected to a data storage device that can store information about stored samples that can be accessed and identified using the RFID tags. At step 960, method 900 can include receiving, from the RFID scanner or a computing device associated with the RFID scanner, an indication of at least one sample or group of samples stored within the first rack. Receiving an indication can include, for example, a human user viewing or otherwise receiving information on or from the output device. For example, receiving an indication can include viewing a list of sample names or identifiers of samples present within the scanned rack or drawer. In some embodiments, the indication can include location information such as a rack identifier, drawer identifier, drawer position, box identifier, information related to a position within a box, or other information useful to a user for identifying a location of a sample.

After step 960, the user can, for example, based on the received indication, opening a drawer of the first rack; locating the desired sample or group of samples, and removing the sample or group of samples from the first rack. As described above, the first rack is at least partially constructed from RF transparent polymer. The RF transparent polymer can be polyethylene terephthalate glycol (PETG). As described above, each of the plurality of racks can include a plurality of drawers. Further, each of the plurality of drawers can be configured to receive a plurality of samples. The drawers can comprise an RF transparent polymer. In some embodiments, a front panel (i.e., drawer front rail 206) is constructed of the RF transparent polymer. As described above, the drawer can include a back panel, a side panel; and a bottom. The front panel, back panel, and side panel can each be solvent-bonded to the bottom.

The various embodiments disclosed in this patent document provide advantages over the prior art, whether standalone or combined. For example, the disclosed embodiments use radio frequency transparent polymer racks to store samples in freezers. Freezers may contain thousands of samples that can be difficult to organize. Thus, locating a particular sample can be time-consuming and difficult. Disclosed embodiments permit use of RFID technology to locate samples, thereby energy usage by reducing the time in which freezer doors remain open, providing cost savings and lowering carbon footprint. Conventional stainless steel racks block RFID signals and can be dangerous to touch when stored at very cold temperatures. By contrasts, the polymers employed in the disclosed embodiments are also safe to human touch, even at temperatures as low as negative 80 degrees Celsius. This is not only safer for the end user, but also eliminates the need for the user to wear thick safety gloves when working in the freezer. Additionally, the visual transparency of disclosed embodiments (as compared to stainless steel), permits user to view samples or boxes through the rack to see, for example, how many (if any) samples or boxes are included in a particular rack or drawer without needing to open all of the drawers of the rack. Again, this can reduce time spent in the freezer and corresponding energy consumption.

Other advantages of the present invention can be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described in this document, but is intended to include all changes and modifications that are within the scope and spirit of the invention as defined in the claims.

1. A freezer storage rack for storing samples in a freezer comprising:
a housing; and
a first drawer disposed within the housing;
wherein at least one of the housing or the first drawer comprises a polymer material and is RF transparent;
wherein at least one of the housing or the drawer is visually transparent.

2. The freezer storage rack of claim 1, wherein the housing and the first drawer both comprise polyethylene terephthalate glycol (PETG).

3. The freezer storage rack of claim 1, wherein at least one of the housing or the drawer comprises a plurality of parts, the plurality of parts being solvent bonded together.

4. The freezer storage rack of claim 1, wherein the housing comprises a plurality of shelves.

5. The freezer storage rack of claim 4, further comprising a second drawer, a third drawer, and a fourth drawer.

6. The freezer storage rack of claim 5, wherein each of the first, second, third, and fourth drawers are disposed within the housing on a different shelf of the plurality of shelves.

7. The freezer storage rack of claim 5, wherein the first, second, third, and fourth drawers are each sized and shaped to receive a plurality of sample boxes.

8. The freezer storage rack of claim 1, wherein the freezer storage rack is configured to function at temperatures between about −25 and −80 degrees Celsius.

9. The freezer storage rack of claim 1, wherein the freezer storage rack is configured to function at temperatures between about −40 and −80 degrees Celsius.

10. The freezer storage rack of claim 1, wherein the freezer storage rack is configured to function at temperatures between about −50 and −80 degrees Celsius.

11. A method for organizing frozen samples comprising:
opening a freezer containing a plurality of samples stored within a plurality of RFID transparent racks;
selecting a first rack of the plurality of racks for scanning;
scanning the first rack using an RFID scanner;
receiving, from the RFID scanner or a computing device associated with the RFID scanner, an indication of at least one sample or group of samples stored within the first rack.

12. The method of claim 11 further comprising:
opening a drawer of the first rack;
locating the sample or group of samples; and
removing the sample or group of samples from the first rack.

13. The method of claim 11, wherein the first rack is at least partially constructed from RF transparent polymer.

14. The method of claim 13, wherein the polymer comprises polyethylene terephthalate glycol (PETG).

15. The method of claim 11, wherein each of the plurality of racks comprises a plurality of drawers.

16. The method of claim 15, wherein each of the plurality of drawers is configured to receive a plurality of samples.

17. The method of claim 15, wherein the drawers comprise an RF transparent polymer.

18. The method of claim 17, wherein the drawer comprises a front panel constructed of the RF transparent polymer.

19. The method of claim 18, wherein the RF transparent polymer comprises polyethylene terephthalate glycol (PETG).

20. The method of claim 18, wherein the drawer further comprises:
a back panel,
a side panel; and
a bottom;
wherein the front panel, back panel, and side panel are each solvent-bonded to the bottom.
